(19) United States
(12) Patent Application Publication
(10) Pub. No.: US 2011/0232260 A1
(43) Pub. Date: Sep. 29, 2011

(54) Ion impulse turbine

(76) Inventor: Richard Cary Phillips, Center Point, AL (US)

(21) Appl. No.: 12/661,825

(22) Filed: Mar. 25, 2010

(51) Int. Cl. F03H 1/00

(52) U.S. Cl. 60/202

(57) ABSTRACT

A turbine power plant which produces power from a plasma and high voltage electricity. A plurality of powerful electric fields are in operation within the turbine. One set of electrodes produce electric fields that charge the plasma to a very high degree of ionization, and forces the plasma to be pressed against a plurality of normally positively charged electrodes making up what is termed the power field. Suddenly, the plurality of electrodes making up the polarization fields are de-energized, and simultaneously, the plurality of electrodes making up the power fields are energized, and repels the plasma at an extremely high velocity into a plurality of turbine blades. As they strike the turbine blades, huge amounts of kinetic energy is transferred to a turbine shaft.

The government has not sponsored any research or development monies of other aids in regard to this application.

### BACKGROUND OF THE INVENTION

a. Technical Field

Drawn to an ion power plant

b. Description of the Prior Art

The Phillips '361 patent uses ions to generate a rotating shaft with a turbine. Also, it heats up a liquid to produce ions, and once the ions are used for propulsion of turbine blades, the ions are condensed thru a condenser, and re-heated again to produce more ions to generate a rotating shaft with the turbine. The improved product significantly improves upon the existing state of the art and advances the use of ions to produce a turbine to a more practical, economical reality. In addition to improving the ions to the propulsion turbine, the present invention utilizes a very highly reactive compound as P₄O₈ which is much easier to polarize than mercury vapor when in the influence of an electric field, cost less, and has few environmental hazards. With a different construction for the polarization electrodes, a different construction for the power electrode, a different ion discharge chamber and configuration. The present invention is superior to the Phillips '361 patent in virtually every way.

### SUMMARY

A turbine power plant which produces power from P₄O₈, a compound of phosphorus, and high voltage electricity. The inner turbine housing is purged from all oxygen and charged with nitrogen gas under a pressure of 5 psig, prior to injecting the P₄O₈ into the chamber. This is a one time charge of the P₄O₈ compound into the inner turbine housing, and it remains there indefinitely. The P₄O₈ compound does not wear out, but should be replaced should it become contaminated in any way. It must be kept away from water, since water will transform the molecule into orthophosphoric acid.

The P₄O₈ molecule has an atomic weight of 252, with 124 electrons surrounding the molecule, a hard crystalline solid at room temperature. It is formed from the P₄O₆ compound when it reaches a temperature of 400 degree C. The compound is very easy to ionize, due to the huge amount of electrons surrounding it, and it is very easy to knock electrons off of its nucleus by a method of ionization known as ionization by collision. It also has the characteristic of having a very high dielectric constant, and easily attracted by a strong negatively charged electrode. This type of attraction is called dielectric polarization. P₄O₈ has a strong affinity for 2 (two) more oxygen atoms to make up its final oxidation state to P₄O₁₀, which is the reason for the nitrogen environment inside the turbine. To facilitate a greater ease in ionizing the P₄O₈ molecules, the turbine is heated to 300 C. in order that the electrons become more loosely connected to the nuclei, and much easier to ionize, when using the method of ionization by collision.

The turbine may have one or more blades. Four blades are optimal.

The turbine has two fields, which is a polarization field and a power field which are turned on/off alternately. The polarization field consists of (1) one normally negatively charged, coil type electrode, located above a circular cone which is the turbine blade support, and more than one, optimally, normally positively charged electrode plates, located in a circular pattern at the base of the turbine, which make up the positive poles of the polarization field.

The process starts when the nuclei of the P₄O₈ mass is accelerated to the top of the apex of the turbine blade support, a flat shaped cone, which is initiated by the attraction of the negatively charged electrode above the top of the turbine blade support. The attraction of the P₄O₈ mass located at the bottom of the inner turbine housing by this negatively charged electrode is called attraction by dielectric polarization. The P₄O₈ mass collides at the apex of the turbine blade support at a very high velocity, and knocks off huge amounts of loosely connected electrons from the P₄O₈ mass. This method of ionization, of the P₄O₈ mass, is called ionization by collision. As the electrons are knocked off the P₄O₈ mass, the electrons are immediately attracted downward, to the (12) twelve positively charged electrodes, located on the bottom plate of the inner turbine housing.

The P₄O₈ mass located at the top of the apex has now been transformed into a highly positively charged P₄O₈ mass, due to the huge amounts of electrons that have been knocked off, and now is pressed against a plurality of normally positively charged electrodes which makes up the positive pole of what is called the power field. The highly charged P₄O₈ mass is held there for only nanoseconds, before it is acted on by the power field. Also, there is an equal negative charge, due to the electrons that were knocked off the molecules, that now surrounds the 12 normally positively charged electrodes of the polarization field, located at the bottom of the inner turbine housing.

The power field is described as follows: There are four (4), optimally, normally positively charged plate electrodes located at the apex of the turbine blade support. Each electrode plate is located at 90 degrees to each other. These electrodes make up the (4) four normally positively charged poles of the power field. There are four (4), optimally, normally negatively charged plate electrodes located near the perimeter of the turbine blade support, with each electrode spaced at 90 degrees to each other, and these electrodes make up the four (4), optimally, normally negatively charged poles of the power field.

The power is produced by the turbine as follows: The polarization field has been energized, which has caused the highly positively charged P₄O₈ mass to congregate at the top of the turbine blade support. The P₄O₈ mass has surrounded the (4) normally positively charged electrodes of the power field, and pressed against these electrodes. Next, the polarization field is de-energized (shut off), releasing its hold on the positively charged P₄O₈ mass pressed against these electrodes. Simultaneously, the (4) four power fields are energized, and the positively charged P₄O₈ mass, which are pressed against the four (4) normally positively charged electrodes are activated (turned on) and simultaneously, the four (4) normally negatively charged electrodes of the power field are activated (turned on).

The released negatively charged electrons at the bottom of the turbine do not have time to travel upward, and unite with the positive charges on the P₄O₈ vapors, to make the P₄O₈ vapors an electrically neutral mass, before the power fields have been actuated (turned on), and repelled the P₄O₈ mass from the surface of the (4) positively charged electrodes, toward the four (4) normally negatively charged electrodes located near the perimeter of the turbine blade support cone.

This invention utilizes Charles Coulomb's Law generating huge electro-static forces when electrical charges of the same “electrical sign” are in close proximity of each other. The following formula by Charles Coulomb is utilized by my invention, and is very important to note the following in the formula: “R” represents the distance between the net positive charge of P₄O₈ mass, and the positive charge on the power electrodes (both have the same electrical sign) and is located in the denominator of this formula. In my invention, by the use of a special polarization field inside the housing, acts on the P₄O₈ mass, and locates the positive charges of the P₄O₈ mass extremely close to the normally positively charged electrodes. Therefore, in my invention, the “R” (distance) in Charles Coulomb's force formula represents an extremely short distance when the P₄O₈ mass is pressed against the electrodes, and is repelled to the (4) turbine blades.

Also, noted by the use of mathematics in analyzing Charles Coulomb's force formula, that as “R” between these charges approach “Zero” (0), which is in the denominator of this formula, then the FORCE generated by my turbine APPROACHES INFINITY. Charles Coulomb's formula is as follows:

$$Repulsion Force = \frac{[ 9 \times {10}^{9} ] [ {Q}_{1} ] [ {Q}_{2} ]}{{R}^{2}}$$

where:
Q₁=Net positive charge of the ions (coulombs)
Q₂=Positive charge on the (power) electrodes (coulombs)
R²=Distance (meter) between the net positive charge of the P₄O₈ ions and the positive charge on the power electrodes (4)
9×10⁹=Constant involving the speed of light (squared)

### Force=Newton

After the positively charged P₄O₈ mass is repelled off the positive charged electrodes, the positively charged P₄O₈ mass travels downward from the apex, at a 20 degree angle, which is the downward slope of the cone, and the mass is attracted by four (4), optimally, negatively charged electrodes, located near the perimeter of the turbine blade support cone. The high velocity P₄O₈ mass cannot stop when it reaches the negatively charged electrodes, and inertia of the mass carries it past the electrodes, and instantly impacts against the turbine blades.

After impact of the P₄O₈ mass on the turbine blades, the mass is deflected at a 90 degree angle to the direction of the on coming P₄O₈ mass.

A turbine hollow shaft is connected vertically through the apex of the turbine blade support, and the P₄O₈ mass striking the turbine blades, rotates the cone shaped, turbine blade support, which rotates the shaft.

The high velocity P₄O₈ mass, striking the turbine blades, knocks off additional electrons, causing an even greater ionization of the P₄O₈ mass.

After the positively charged P₄O₈ mass strikes the turbine blades producing torque to the shaft, the power field is de-energized, (shut off), and simultaneously the polarization field is again energized, and the positively charged P₄O₈ mass of the nuclei once again travels upward and presses against the normally positively charged electrodes of the power field, and the loose electrons, after collision, go down to the bottom of the chamber. The cycle then repeats itself over and over.

The P₄O₈ mass inside the turbine can be cycled, inside the inner turbine housing, at a very fast rate of speed, since charged particles can travel very fast in an electric field, and all electric fields travel at the speed of light.

Power is produced to the shaft then to the electrical generator on each cycle that the P₄O₈ mass makes. Therefore, the greater the number of cycles, per unit of time, the greater the power is produced to the electrical generator. The power (foot pounds/unit of time) to the shaft is controlled by the electric intensity of the polarization field, and the electric intensity of the power fields which are generated inside the turbine. The higher the electric intensity of these fields, then the greater the cycles, per unit of time, and the greater the power to the generator.

Also, when in operation of the power field, and the repulsion of the positively charged electrodes acts against the P₄O₈ mass, an ion guide plate is provided to deflect any scattered high velocity ions into the turbine blades for additional energy to the turbine shaft.

A water jacket, with its associated water pump, is located around the outside surface of the inner turbine housing. The water jacket is provided for the following two (2) reasons: 1) To cool down the heated plates, generated by friction of the P₄O₈ mass continually being deflected off the blades, and striking the vertical plates of the inner turbine housing. 2) The hot water generated in the water jacket can be pumped to heating coils located at remote air handling units. Therefore, hot air can be ducted to heat up buildings during the winter season.

### BRIEF DESCRIPTION OF DRAWINGS

FIG. 1 is showing the general arrangement of cross section thru turbine

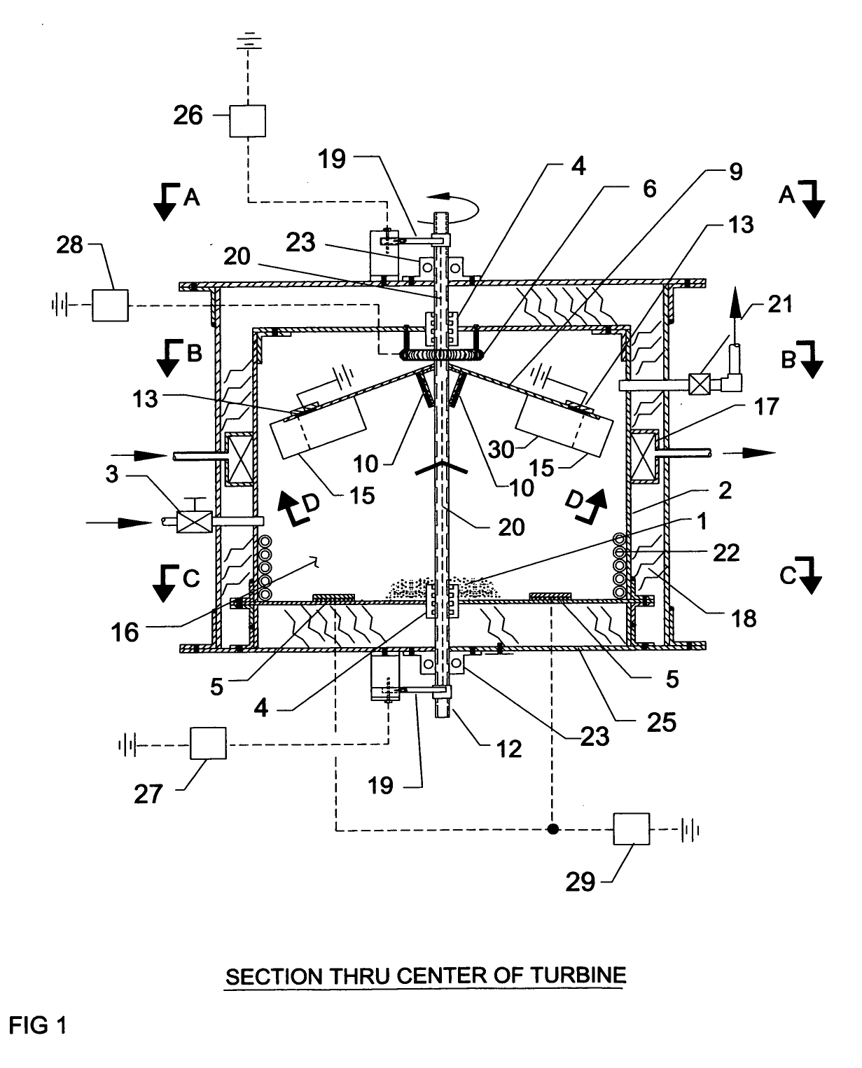

FIG. 2 is section A-A showing top view of turbine & Section B-B showing top view of turbine blade support

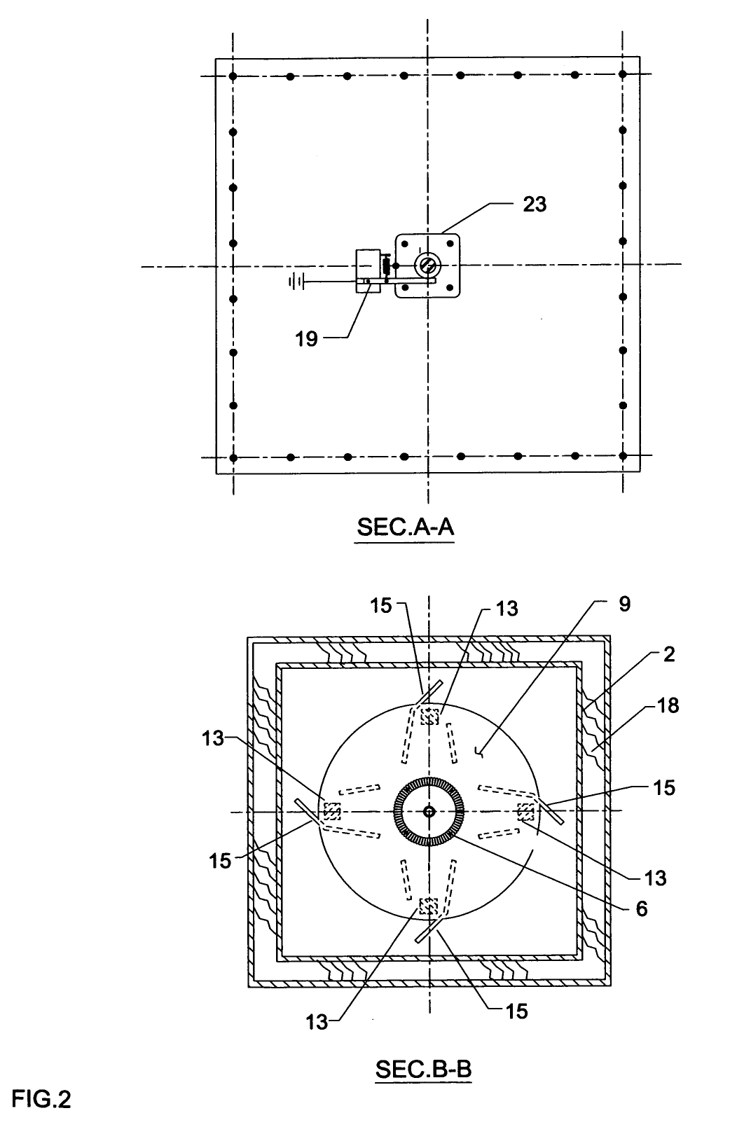

FIG. 3 is View D-D of turbine blade supports, turbine blades & ion guide plates

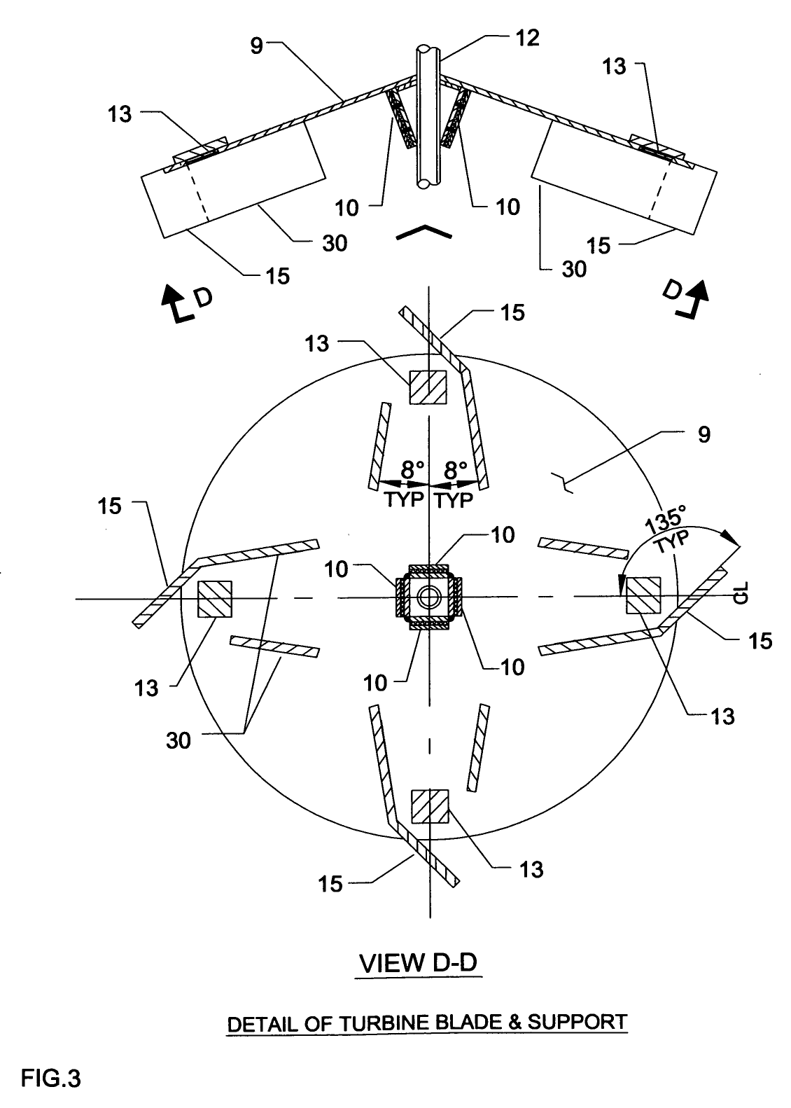

FIG. 4 is Section C-C of the Polarization Field Electrodes, and heating coils

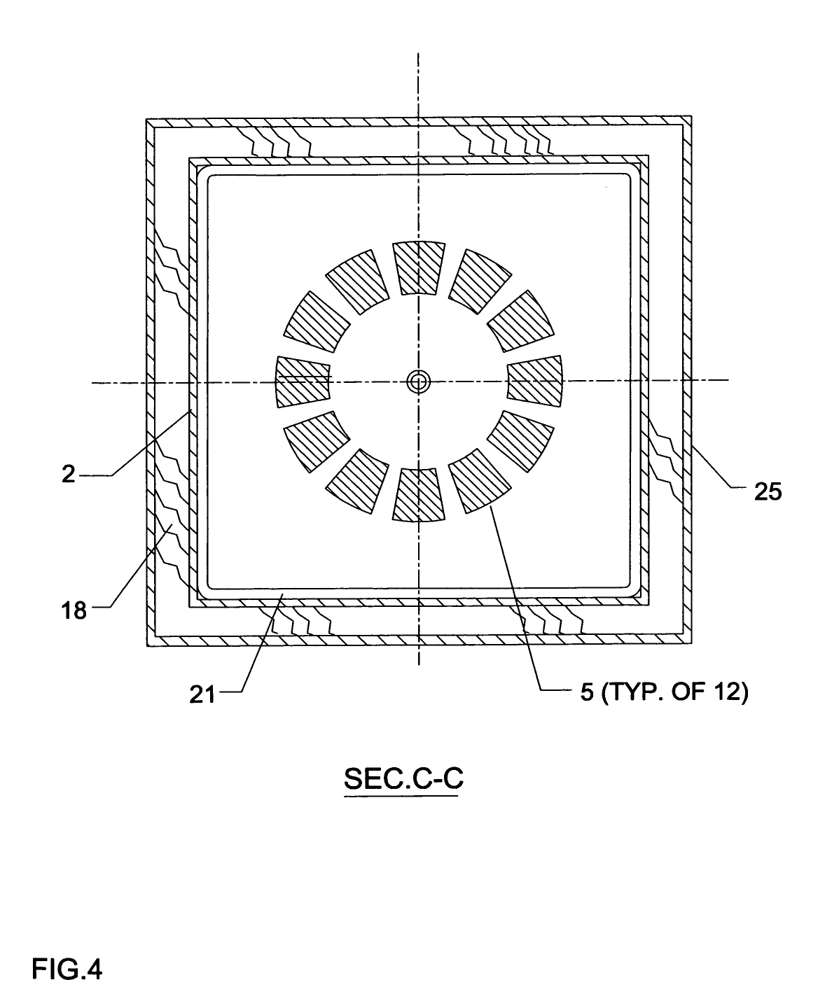

FIG. 5 is a diagrammatic view showing the process of Power Generation

FIG. 6 is a diagrammatic view showing high voltage electrical supply to electrodes

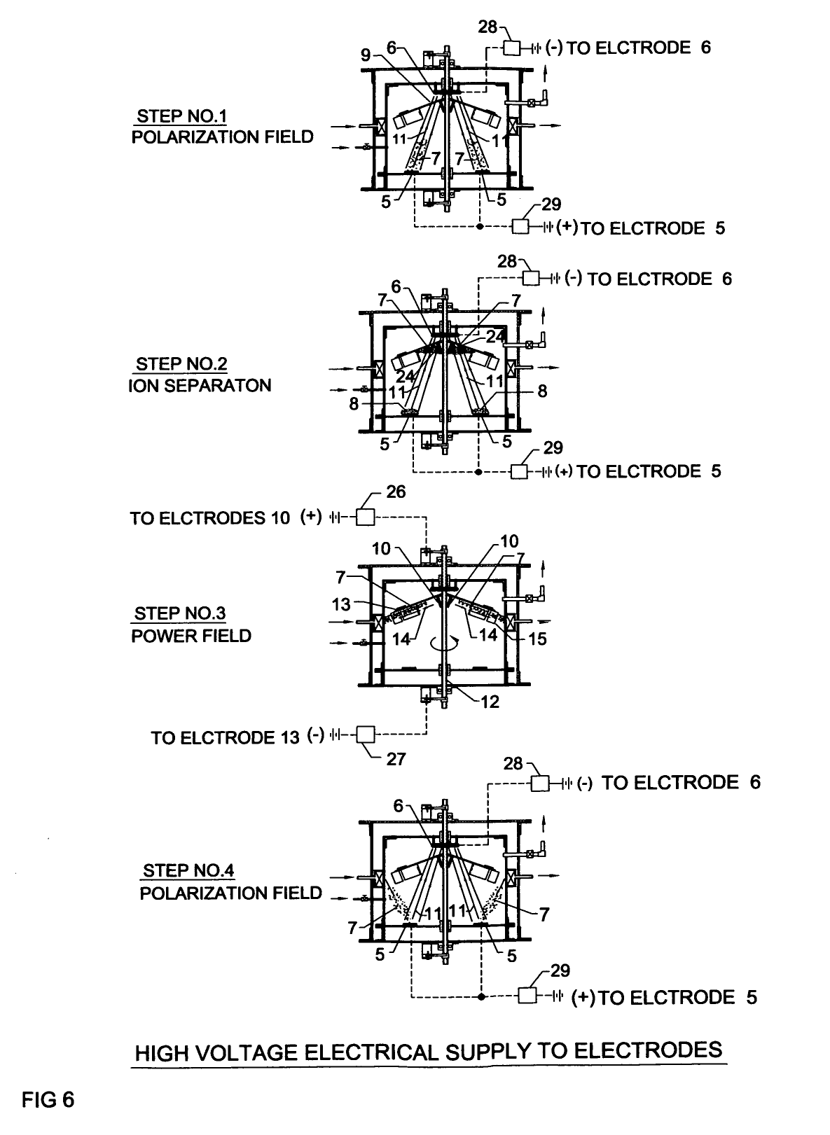

### DETAILED DESCRIPTION OF THE PREFERRED EMBODIMENTS

The purpose of this turbine is to produce power from a phosphorus compound, called P₄O₈, and high voltage electricity. P₄O₈ (1) is made from P₄O₆, and is only two (2) oxygen atoms away from fertilizer, P₄O₁₀. If it escapes from the turbine, it is harmless to the environment, unlike combustion products of automobiles, airplanes, and rockets. It quickly decomposes to other environmentally less hazardous products than chemical fuels, solid fuels, mercury or other propellents, consequently the use of P₄O₈ is both the most effective substance and the least harmful.

A measured, and specific volume of P₄O₈ is placed inside the inner turbine housing (2), filled with pressurized nitrogen gas (16). The P₄O₈ enters the inner turbine housing through the entry shut off valve (3), after the inner turbine housing has been heated to 300 degree C. This is required in order to expand the P₄O₈ molecules, and cause the electrons to be more loosely connected, making the P₄O₈ molecules easier to ionize by the method called ionization by collision.

After P₄O₈ molecules are heated to 300 degree C., a polarization field (11) is created by twelve (12) positively charged electrodes (5), located at the bottom of the inner turbine housing, and one (1) negatively charged coil type electrode (6), located above the apex of the turbine blade support (9). As the polarization field takes place through the P₄O₈ mass, it creates a separation of the net positive charge of the P₄O₈ mass from the net negative charge of the free electrons (8) within the P₄O₈ mass. The net positive charge of the P₄O₈ mass (7) are attracted upward, toward the negatively charged electrode (6), and the net negative charge of the electrons (8) are attracted downward toward the positively charged electrodes, within the P₄O₈ mass, as opposite charges attract and same charges repel.

Also, during the energizing of the polarization field upon the P₄O₈ mass, there are huge numbers of electrons within the P₄O₈ mass that are knocked off the nucleus by collision against the turbine blade support (9), and are attracted downward by the twelve (12) positively charged electrodes (5) located at the base of the inner turbine housing (2).

It is noted that the positively charged nuclei of the P₄O₈ mass, as it is traveling upward toward the negatively charged electrode (6) of the polarization field, does not make contact with this electrode, but collides with the apex of the cone of the turbine blade support (9), which is immediately in front of this electrode (6). Due to the additional removal of the electrons by the method of ionization by collision, this creates an overall high state of the positive ionization of the P₄O₈ mass.

To further discuss this process, the net positive charge within the P₄O₈ mass, composed of the nuclei of the P₄O₈ mass, are attracted upward toward the energized negatively charged polarization electrode (6), and are compressed against the de-energized (4) normally positively charged electrodes (10), which are immediately in front of the normally negatively charged polarization electrode (6). The net negative charge of the P₄O₈ mass, composed of the mobile free electrons (8), are attracted downward toward the (12) energized positively charged electrodes (5).

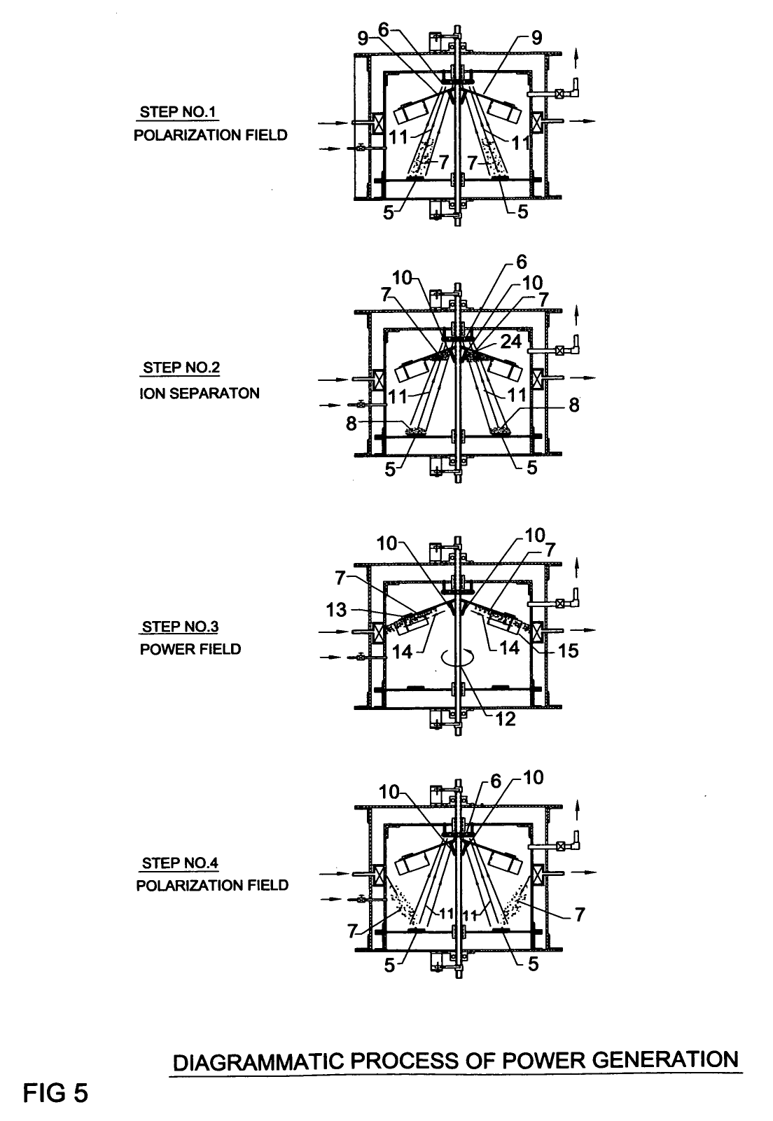

Therefore, the function of the polarization field is to create a separation between the net positive charge of the nuclei of the P₄O₈ mass, and the net negative charge of the mobile free electrons knocked off the P₄O₈ mass, while forcing the positively charged P₄O₈ mass as close as physically possible to the unenergized four (4) electrodes (10). This reduces the “R” in the equation to as close to “zero” as practical. See FIG. 5, step 2, for diagrammatic process of ion separation.

A huge force, by the nuclei of the P₄O₈ mass, is generated on the turbine blades when the polarization field (11) is de-energized (turned off), and the four (4) positively charged power electrodes (10), called power electrodes, are energized (turned on) while the net positive charge of the P₄O₈ mass is pressed very close to the surface (24), and simultaneously, the four (4) negatively charged electrodes (13) of the power field are energized.

When in operation of the power field, and the repulsion of the positively charged electrodes (10) acts against the P₄O₈ mass, an ion guide plate (30) is provided to deflect any scattered high velocity P₄O₈ ions into the turbine blades for additional energy to the turbine shaft.

To further explain this process, the positively charged P₄O₈ mass (7) is repelled away from the surface of the energized four (4) positively charged power electrodes (10), and attracted by the negatively charged electrodes (13), creating power field (14).

A huge velocity and force is generated by the P₄O₈ mass, as it hits the turbine blades (15) and deflecting the mass at a 90 degree angle to the direction of the on coming P₄O₈ mass. This creates a huge torque on the turbine shaft (12), which is located through the apex of the turbine blade support cone. As this huge torque is generated on the turbine shaft, it transfers this power to the electrical generator (31) which produces current electricity.

The electrical power supply (26) furnishes power to the positively charged electrodes (10), and the electrical power supply (27) furnishes power to the positively charged electrodes (13). The electrical power supply (28) furnishes power to the negatively charged electrode (6), and the electrical power supply (29) furnishes power to the positively charged electrodes (5)

A pressure relief valve (21) set at 5 psig to relieve pressure, should pressure become excessive on the inner turbine housing (2).

Any method of providing high voltage electrical power necessary for the operation of this turbine is permitted and acceptable, and any computerized time controller is acceptable to alternately energize the polarization field (11), and the power field (14), to regulate the torque on the shaft over a sustained time.

Carbon brush/brass commutators (19) are provided to furnish electricity through conductors (20) to the electrodes (10) & (13) on the rotating turbine blade support cone.

Also, there is a water jacket (17) located outside the inner turbine housing (2) to take out the excess heat that is generated by the friction, due to the constant impact of the P₄O₈ mass, deflected off of the turbine blades, and striking the inside wall of the inner turbine housing (2). The excess heat generated inside the water jacket is sent to a cooling tower and re-circulated back to the turbine, or sent to heating coils inside an air handling unit to heat up buildings during the winter season, and then re-circulated back to the turbines' water jacket.

Also, there is thermal insulation (18) around the outer wall of the inner turbine housing (2) to keep heat from escaping from inside the inner turbine housing.

Heating coils (22) are located around the bottom portion of the inner turbine housing to heat the inside of the chamber formed by the inner turbine housing up to 300 degree C. at the start of the turbines' operation.

Two shaft seals (4) are located inside inner turbine housing to keep, as much as possible, any P₄O₈ mass from escaping to the outside of the inner turbine housing.

Bearings (23) are located at the top and bottom of the outer surface of the outer turbine chamber (25) to provide smooth rotation for the turbines hollow shaft (12).

It is noted that the turbine blade support (9), a flat shaped cone, should ideally be constructed of beryllium, due to the micro-wave effect of the polarization field constantly pulsating through the turbine blade support (9). Any ferric metals used for the construction of the turbine blade support would get extremely hot due to the micro-wave effect. Steel would not be as effective as beryllium, because beryllium has the unique physical characteristic to allow electro-magnetic waves, of the polarization field, to travel rapidly, back and forth, through beryllium freely, with very little resistance to get it hot. Also, with the P₄O₈ mass constantly striking the turbine blade support (9), making it out of beryllium would be less wear than steel, since beryllium is a much harder, and stronger, substance than steel. Also, beryllium would give the turbine greater power, and efficiency, in rotating turbine blade support and power shaft, since beryllium is ⅔ the density of aluminum.

I claim:

1. An ion turbine housing; a closed housing having one side referred to as the bottom side of the housing and another side referred to as the top side of the housing;
a means for the entry of an electrical neutral P₄O₈ mass into the housing;
a means for the entry of nitrogen gas into the housing;
a means to purge air from inside the housing, sufficient to provide a nitrogen gas environment inside the housing;
a means to supply nitrogen to the inside of the housing;
a shaft with a hollow core running entirely through the housing and the shaft extending beyond the housing on at least one end, entering into the housing through the top side and exiting the housing through the bottom side;
turbine shaft pressure seals sufficient to keep the pressurized nitrogen gas from escaping from the turbine housing to the environment disposed at the locations where the turbine shaft passes through the housing;
a plurality of normally positively charged electrodes attached at the bottom side of the housing;
a turbine blade support cone, attached to the shaft near the location where the shaft exits the top side of the turbine housing and disposed such that the apex of the cone is the portion of the cone attached to the shaft with an angle relative to the shaft less than 90 degrees;
a negatively charged electrode attached to the housing above the apex of the turbine blade support cone;
a means to energize the negative electrode and the plurality of positive electrodes at the same time;
a plurality of power electrodes consisting of (1. plurality of positive electrodes attached to the turbine blade support cone and to the shaft, and (2. plurality of negative electrodes located near the perimeter of the turbine blade support cone;
a means to de-energize the negative electrode and the plurality of positively charged electrodes, while simultaneously energizing the plurality of positive and negative power electrodes;
a plurality of turbine blades, connected to the turbine blade support cone, disposed at an angle to the turbine blade support cone;
a means to deflect scattered ions into the turbine blades;
a plurality of ion guide plates connected to the turbine blade support cone, disposed at an angle to the turbine blade support cone.

2. An ion turbine housing; a closed outer turbine housing;
a closed inner housing entirely inside the outer turbine housing, having one side referred to as the bottom side of the housing and another side referred to as the top side of the housing;
a means for the entry of an electrical neutral P₄O₈ mass into the housing;
a means for the entry of nitrogen gas into the housing;
a means to initially heat the inner turbine housing to 300 degrees Centigrade;
a means to purge air from inside the housing, sufficient to provide a nitrogen gas environment inside the housing;
a means to supply nitrogen to the inside of the housing;
a pressure relief valve disposed to prevent nitrogen gas from over pressurization of the inner turbine housing;
a shaft with a hollow core running entirely through the housing and the shaft extending beyond the housing on at least one end, entering into the housing through the top side and exiting the housing through the bottom side;
turbine shaft pressure seals sufficient to keep the pressurized nitrogen gas from escaping from the turbine housing to the environment disposed at the locations where the turbine shaft passes through the inner housing;
a plurality of normally positively charged electrodes attached at the bottom side of the housing;
a turbine blade support cone, made of beryllium, attached to the shaft near the location where the shaft exits the top side of the turbine housing and disposed such that the apex of the cone is the portion of the cone attached to the shaft with an angle relative to the shaft less than 90 degrees;
a negatively charged electrode attached to the housing above the apex of the turbine blade support cone;
a means to energize the negative electrode and the plurality of positive electrodes at the same time;
a plurality of power electrodes consisting of (1. plurality of positive electrodes attached to the turbine blade support cone and to the shaft, and (2. plurality of negative electrodes located near the perimeter of the turbine blade support cone;
a means to de-energize the negative electrode and the plurality of positively charged electrodes, while simultaneously energizing the plurality of positive and negative power electrodes;
a plurality of turbine blades, connected to the turbine blade support cone, disposed at an angle of 135 degrees to the turbine blade support cone;
a means to deflect scattered ions into the turbine blades;
a plurality of ion deflection plates, connected to the turbine blade support cone, disposed at an angle of 8 degrees to the turbine blade support cone.
a water jacket to surround the outer surface of the inner turbine housing to remove heat generated, by friction, due to the P₄O₈ mass continually striking the surface of the inner turbine housing;
thermal insulation located between the inner turbine housing, and the outer turbine housing;
